(19) United States
(12) Patent Application Publication
(10) Pub. No.: US 2009/0102168 A1
(43) Pub. Date: Apr. 23, 2009

(54) DOOR OF PASSENGER AIR BAG FOR VEHICLE

(76) Inventor: Hyun Kim, Hwaseong-si (KR)

Correspondence Address: MORGAN, LEWIS & BOCKIUS LLP (SF), One Market, Spear Street Tower, Suite 2800, San Francisco, CA, 94105, US

(21) Appl. No.: 12/061,930

(22) Filed: Apr. 3, 2008

(30) Foreign Application Priority Data
Oct. 23, 2007 (KR) 10-2007-0106672
Nov. 27, 2007 (KR) 10-2007-0121501

(51) Int. Cl. B60R 21/215

(52) U.S. Cl. 280/728.3

(57) ABSTRACT

A door of a passenger air bag for a vehicle has a tear line along which the passenger air bag is deployed. A protruding portion is formed along the tear line, and a heating member is installed on the protruding portion along the tear line.

### CROSS-REFERENCE TO RELATED APPLICATIONS

This application claims priority to Korean Application No. 10-2007-0121501, filed on Nov. 27, 2007, the disclosure of which is incorporated herein by reference.

### BACKGROUND OF THE INVENTION

1. Field of the Invention

The present invention relates to a door of a passenger air bag for a vehicle and, more particularly, to a door of a passenger air bag for a vehicle which allows a skin to be neatly torn along a tear line even at a low temperature.

2. Description of the Prior Art

As is well known in the art, a passenger air bag is installed in an instrument panel in front of a passenger seat and is deployed by tearing the instrument panel in the event of a collision.

FIG. 1 illustrates a passenger compartment of a vehicle which has a conventional passenger air bag installed therein. In order to ensure smooth deployment of the passenger air bag, a tear line L is formed in an instrument panel 1. In general, the tear line L is formed on the inner portion of the instrument panel 1 so that the outer appearance of the instrument panel 1 is not marred.

The deployment structure of a passenger air bag 10 will be described with reference to FIGS. 1 and 2.

The passenger airbag 10 has a housing 12 for receiving an airbag 11 and an inflator 13. An air bag door 3 is provided on the passenger air bag 10 to cover the opening 6 defined in the instrument panel 1. The air bag door 3 is fastened to the core 2 of the instrument panel 1. A piece of foam 4 and a skin 5 are continuously positioned on the airbag door 3. When the air bag 11 is inflated, the air bag 11 is deployed by tearing a tear line L which is formed in the piece of foam 4 and the skin 5.

The related arts, which are published in relation to the deployment structure of a passenger air bag having a tear line formed such that it cannot be seen from the outside, include U.S. Unexamined Patent Publication No. 20050080605 (dated Apr. 14, 2005) and U.S. Pat. No. 6,210,614 (dated Apr. 3, 2001).

However, the conventional passenger airbag 10, constructed as mentioned above, has a problem in that, when the air bag 11 is deployed at a low temperature, the skin 5 is likely to be irregularly torn to thus form a sharp portion. That is to say, as shown in FIG. 3, when the air bag 11 is deployed, the skin 5 is not neatly torn along the tear line L, and thus the sharp portion formed in the torn skin 5 can hurt a passenger's face or eye. In the case of currently used skins, which are made of PVC, the above-described problem is particularly serious, and yet no measure for solving this problem has been disclosed in the art.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Accordingly, the present invention has been made keeping in mind the above problems occurring in the prior art, and an object of the present invention is to provide a door of a passenger air bag for a vehicle which has an improved structure for allowing a skin to be neatly torn along a tear line even at a low temperature.

In order to achieve the above object, according to an exemplary embodiment of the present invention, there is provided a door of a passenger air bag for a vehicle, having a tear line along which the passenger air bag is deployed, wherein a protruding portion is formed along the tear line, and a heating member is installed on the protruding portion along the tear line.

The heat generated by the heating member is transferred to the tear lines formed in a piece of foam and a skin, which are placed on an air bag door, so that the skin can be neatly torn along the tear line thereof even at a low temperature. Further, due to the presence of the protruding portion, the distance between the heating member and the skin placed over the passenger air bag decreases, and therefore, the heat generated by the heating member can be quickly transferred to the tear line of the skin.

It is necessary for the heating member to be installed at a position from which the heat of the heating member can be easily transferred to the tear line of the skin. Preferably, the heating member is installed on the upper portion of the protruding portion, and the tear line is formed on the lower portion of the protruding portion. The heating member can be coated or attached to the upper portion of the air bag door. Alternatively, the heating member can be embedded into the upper portion of the air bag door.

The heating member may comprise a heating wire. An insertion groove is defined alongside the tear line, and the heating wire is fitted into the insertion groove. Preferably, the heating member is installed such that it extends along the entire length of the tear line.

### BRIEF DESCRIPTION OF THE DRAWINGS

The above and other features of the present invention will now be described in detail with reference to certain exemplary embodiments thereof illustrated the accompanying drawings which are given hereinbelow by way of illustration, and thus are not limitative of the present invention, and wherein:

FIG. 1 is a perspective view illustrating a passenger compartment of a vehicle which has a conventional passenger air bag installed therein;

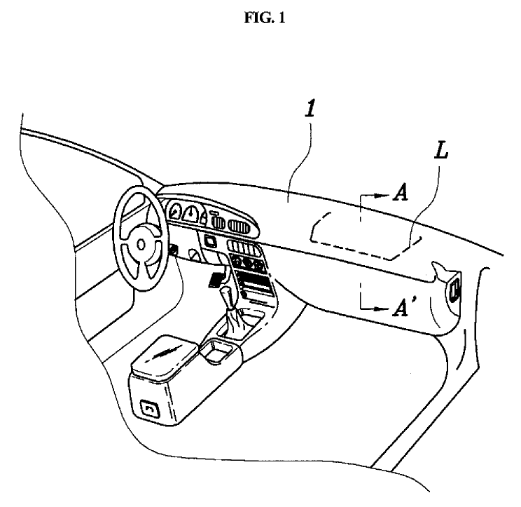

FIG. 2 is a cross-sectional view taken along the line A-A′ of FIG. 1;

FIG. 3 is a photograph illustrating a problem which is caused when the conventional passenger air bag is deployed at a low temperature;

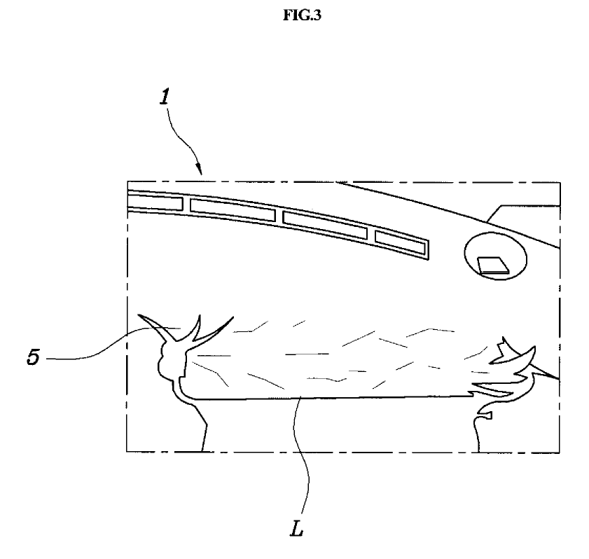

FIG. 4 is a cross-sectional view illustrating a door of a passenger airbag for a vehicle in accordance with an exemplary embodiment of the present invention; and

FIG. 5 is an exploded perspective view illustrating the door of a passenger air bag for a vehicle in accordance with the exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF A PREFERRED EMBODIMENT

Reference will now be made in detail to a preferred embodiment of the present invention, an example of which is illustrated in the accompanying drawings and described below. While the invention will be described in conjunction with an exemplary embodiment, it should be understood that the description is not intended to limit the invention to the exemplary embodiment. On the contrary, the invention is intended to cover not only the exemplary embodiment, but also various alternatives, modifications, equivalents and other embodiments, which may be included within the spirit and scope of the invention as defined by the appended claims.

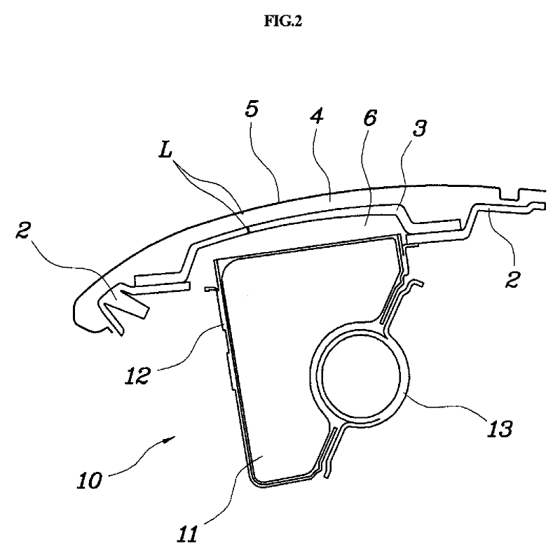

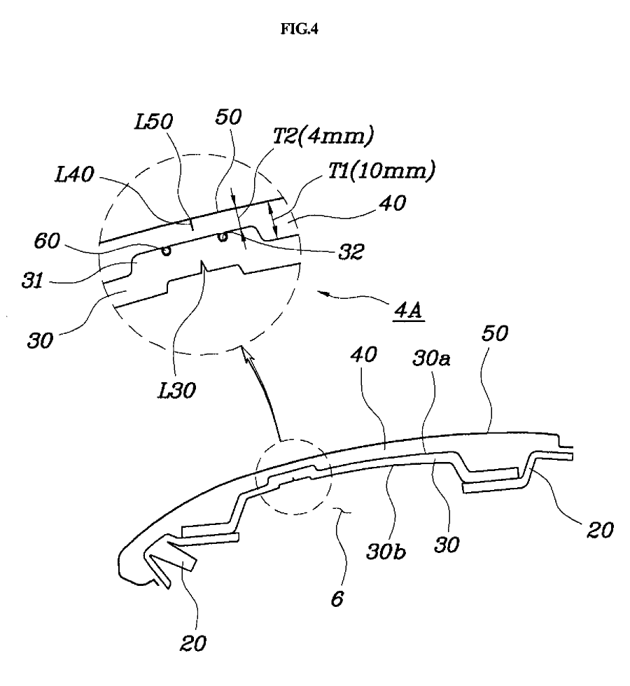

FIG. 4 is a cross-sectional view similar to FIG. 2, illustrating an instrument panel in which a door of a passenger air bag for a vehicle in accordance with an exemplary embodiment of the present invention is installed.

Referring to FIG. 4, an air bag door 30 is installed on a core 20 in the opening 6 defined in the instrument panel. A piece of foam 40 and a skin 50 are positioned on the air bag door 30 continuously.

The piece of foam 40 is placed between the air bag door 30 and the skin 50, and a tear line L40 is formed on the upper portion of the piece of foam 40. The skin 50 is exposed to the passenger compartment, and a tear line L50 is formed in the lower portion of the skin 50.

The air bag door 30 has a protruding portion 31 which protrudes upward.

A heating wire 60 is embedded in an upper portion 30a of the protruding portion 31, and a tear line L30 is formed in the lower portion of the protruding portion 31. The tear lines L30, L40 and L50 are arranged in an area defined by the protruding portion 31 so that the tear lines L30, L40 and L50 can be easily torn all together when the air bag deploys. Preferably, the L30, L40 and L50 is aligned substantially in a same perpendicular direction. And, the tear lines L30, L40 and L50 of the air bag door 30, the piece of foam 40 and the skin 50 are positioned continuously stacked so that, when heat is generated by the hating wire 60, the heat can be transferred to the tear lines L30, L40 and L50 of the respective parts 30, 40 and 50.

In FIG. 4, the dotted circle, indicated by reference symbol 4A, illustrates an enlarged view of the region including the tear lines L30, L40 and L50.

The distance between the upper portion of the protruding portion 31 and the skin 50 is set to be shorter than the distance between the upper portion of the protruding portion 31 and the upper portion 30a of the airbag door 30.

In an exemplary embodiment of the present invention, the distance between the upper portion 30a of the airbag door 30 and the skin 50 is set to about 0 mm, and the distance between the upper portion of the protruding portion 31 and the skin 50 is set to about 4 mm. In order to ensure that the deployment of the passenger air bag is not hindered by the protruding portion 31 thus formed, the protruding portion 31 has substantially the same thickness as the rest of the air bag door 30.

An insertion groove 32 is defined in the upper portion of the protruding portion 31, and the heating wire 60 is fitted into the insertion groove 32. Therefore, since the distance between the upper portion of the protruding portion 31 and the skin 50 is short, when heat is generated by the heating wire 60 positioned at the upper portion of the protruding portion 31, the heat can be quickly transferred to the skin 50 to make the skin 50 neatly torn along the tear line L50. The tear line L30 is formed on the lower portion of the protruding portion 31 of the air bag door 30.

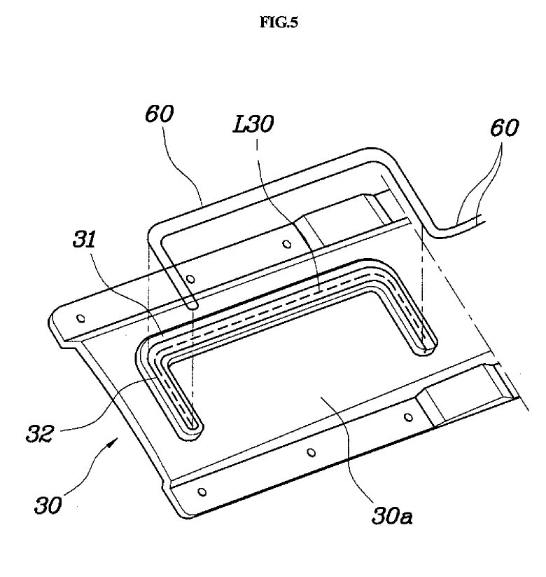

The arrangement by which the heating wire 60 is installed on the protruding portion 31 will be described with reference to FIGS. 4 and 5.

The protruding portion 31 is formed along the tear line L30 of the air bag door 30, and the insertion groove 32 for the heating wire 60 is defined on both sides of the tear line L30 along the tear line L30 in an exemplary embodiment of the present invention. The heating wire 60 is fitted into the insertion groove 32. The insertion groove 32 is defined along the entire length of the tear line L30 so that, as shown in FIG. 5, the tear line L30 formed on the lower portion of the protruding portion 31 is surrounded by the heating wire 60.

A connector (not shown) for supplying electrical power is secured to the terminal ends of the heating wire 60.

In order to ensure that the skin 50 is neatly torn along the tear line L50 due to the presence of the air bag door 30 having the heating wire 60 even at a low temperature, it is necessary to raise the temperature on the tear line L50 of the skin 50 before the passenger air bag air is deployed. To this end, as an exemplary embodiment of the present invention, it is possible to adopt a method in which electrical power is always supplied to the heating wire 60 below a predetermined temperature, or as an another exemplary embodiment of the present invention, a method in which electrical power is supplied to the heating wire 60 below a predetermined temperature only when it is determined that the likelihood of a collision between vehicles increases. The likelihood of a collision between vehicles can be determined by an adaptive cruise control (ACC) system, an air bag control unit (ACU), or an advanced safety vehicle (ASV).

As is apparent from the above description, the door for a passenger air bag for a vehicle according to the present invention, constructed as mentioned above, provides advantages in that, since the temperature of a skin along a tear line is increased in advance before the deployment of the passenger air bag, the skin can be neatly torn along the tear line even at a low temperature.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A door of a passenger air bag for a vehicle, comprising:
a first tear line under which the passenger air bag is deployed;
a protruding portion formed on a portion of an air bag door, along the first tear line; and
a heating member installed at the protruding portion along the tear line.

2. The door of a passenger air bag according to claim 1, further comprising:
a second tear line placed in an upper portion of a piece of foam; and
a third tear line placed in a lower portion of a skin, wherein the first tear line, the second tear line, and the third tear line are arranged in an area defined by the protruding portion.

3. The door of a passenger air bag according to claim 1, wherein the heating member extends along an entire length of the first tear line.

4. The door of a passenger air bag according to claim 1, wherein an insertion groove is formed at an upper portion of the protruding portion, and the heating member is fitted into the insertion groove.

5. The door of a passenger air bag according to claim 1, wherein the first tear line is formed in a lower portion of the protruding portion.

6. The door of a passenger air bag according to claim 1, wherein the heating member is a heating wire.

7. The door of a passenger air bag according to claim 4, wherein the insertion groove extends along the fist tear line in a side-by-side relationship.

8. The door of a passenger air bag according to claim 4, wherein an insertion groove substantially encloses the first tear line in a side-by-side relationship.

9. The door of a passenger air bag according to claim 4, the distance between a skin and an upper portion of the protruding portion is shorter than the distance between the upper portion of the protruding portion and an upper portion of the air bag door

10. The door of a passenger air bag according to claim 8, the distance between the skin and the upper portion of the air bag door is about 10 mm.

11. The door of a passenger air bag according to claim 8, the distance between the skin and the upper portion of the protruding portion is about 4 mm.

12. The door of a passenger air bag according to claim 1, the thickness of the protruding portion is substantially the same as the thickness of the air bag door.

13. The door of a passenger air bag according to claim 1, wherein the heating member is coated or attached to an upper portion of the protruding portion.

14. The door of a passenger air bag according to claim 1, wherein the heating member is embedded into an upper portion of the protruding portion.

15. The door of a passenger air bag according to claim 1, electrical power is always supplied to the heating member below a predetermined temperature.

16. The door of a passenger airbag according to claim 1, electrical power is supplied to the heating member in advance below a predetermined temperature only if a vehicle collision is expected.

17. The door of a passenger air bag according to claim 15, wherein the vehicle collision is determined by an adaptive cruise control (ACC) system, an air bag control unit (ACU), or an advanced safety vehicle (ASV).

18. A door of a passenger airbag for a vehicle comprising:
a first tear line under which the passenger air bag is deployed;
a heating member installed at a portion of the door of a passenger air bag.
